(19) United States
(12) Patent Application Publication
(10) Pub. No.: US 2016/0223443 A1
(43) Pub. Date: Aug. 4, 2016

(54) Laser enabled light centrifuge

(71) Applicant: Michael Francis Wicnienski, Lindenhurst, IL (US)

(72) Inventor: Michael Francis Wicnienski, Lindenhurst, IL (US)

(21) Appl. No.: 14/544,660

(22) Filed: Feb. 2, 2015

(51) Int. Cl. G01N 1/44

(52) U.S. Cl. CPC G01N 1/44

(57) ABSTRACT

Light has evaded analysis as to just what it is. It is said to be a wavicle with both properties of a wave and a particle. This novel application of a laser and a centrifugal element separates particles from light. It does this by accelerating coherent light into a circular centrifugal path that spins the light spun at approximately 0.1127 tera RPM

### BACKGROUND OF THE INVENTION

Light has been found fascinating and even deserving of worship since the earliest traditions of history of the human race. Light is sensed by the eye of humans and animals and is essential to everything from signing you name to finding your way to going to your daily chores to retiring for recreation, the recreation often depending upon the eye for successful accomplishment. Sight is one of the five basic senses of a fully functional human being. Light enables vision.

But what is light? When I attended college, physics taught that light was a wavicle in nature, travelling at the speed of light but having some characteristics only typical of a wave while other observed behavior is found to be more characteristic of particles. No one knows how to store light, and manipulations of it are done with optics like prisms, gratings and lenses while the fundamental nature remains obscure.

Lasers were introduced into usage in the 1950's and 60's. These light sources have found wide application in measuring instruments, sound recording and playback, in laboratory instruments even to direct chemical concentration as in the Grace/Alltech ELSD 3000 ES. Lasers may be had in frequencies of infrared to UV. Diode lasers have greatly disposed of gas lasers in industry and trade, where their long lifetime, variety of wavelengths, and low cost gave ready acceptance to them. They typically have long coherence wavelengths such as the World Star Technologies (Toronto, Ontario, Canada) UH5-100-658 100 mw 658 nanometer 4 volt DC supply requirement which I used in my examinations to be discussed presently.

One topic not mentioned yet is the great utility centrifuges have found in one form or another, to separate minerals of interest from minerals of no economic import, depending upon the centrifuge to separate samples based on differences in sample densities, Centrifuge technology has advanced and made new inroads into design sophistication and utility as needs have grown in different fields to separate materials according to different densities. Continuous flow cell separators were advanced and marketed by Baxter Healthcare/Fenwal Division and Fresenius to harvest plasma, red cells, white cells, and various blood products from living human donors. Centrifuges are widely used in the chemical industry to treat or separate product.

I believe I have now made a laser material and power source that uses basic centrifuge techniques and design to process laser light. Discussion of the design, operation, and some of the characteristics of operation are discussed to the limits of my experience with the early design.

### DETAILS OF THE INVENTION

I originally wanted to experiment with a centrifuge coupled to a laser where the centrifuge would have a 1 inch diameter, readily machined on a vertical mill or lathe to yield a 2(π)r value of π inches, and a hole drilled halfway down would be π/4 inches from the laser input port, The laser is temporarily attached to the side if the centrifuge with modeling clay. The bottom surface of the centrifuge is π/2 inches from the laser port. Since the laser drives the light forward in this application and supplies photon movement a great simplification to the centrifuge is possible. See FIG. 1, Done with Microsoft Paint 5A shows the front view, FIG. 1B the top view, and FIG. 1C shows the side view of the centrifuge core.

The UH5-100-658 laser had its leads lengthened and connected to the 5 volt output of a Power One triple DC supply. The laser was temporarily connected to the centrifuge and energized after I had put on protective eyewear.

The laser light travels a speed of 299,792,458 m/sec. The laser was collimated before use, We were never taught about distortion or interaction when the laser beam travels at the inside diameter of the centrifuge, The speed may be calculated:

Revolutions per minute, RPM==((299,792,458M/sec)*(39.37in/M)*(60sec/min))/((2*π)in/rev)=1,127E11RPM=1.127 hundred billion RPM=0.1127 tera RPM

After several hours of light centrifuge operation a group of bright points separated from the laser beam about ⅜ inch downstream of the laser port at the top center of the centrifuge, Color was whitish yellow. Something remains behind when the laser is turned off, but only appears as bright points again when the laser is once again turned on.

It is hoped that this analytical methodology might shed some understanding on the tough dog problems of the human race such as economics, energy, the weather, cancer, breast cancer, aging, diseases such as scleroderma and lyme disease, and potential cures.

### DETAILS OF THE DRAWING

FIG. 1A Centrifuge top view

FIG. 1B Centrihuge front view

FIG. 1C Cenreifuge side view

What is claimed is:

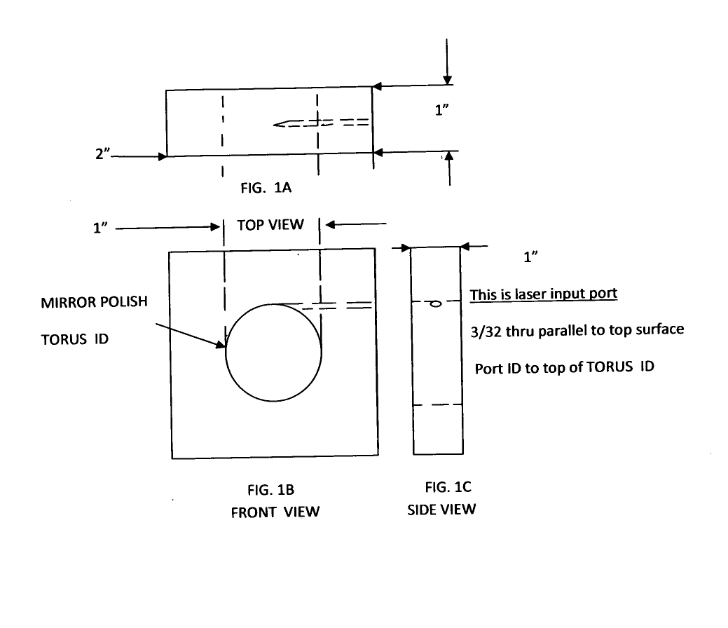

1. A laser coupled to laser port of the inside diameter of an aluminum block of sufficient thickness as to prevent the laser beam following the inner diameter from bleeding off the edge of the block, the block being machined according to the outline of FIG. 1, the laser being also coupled to a suitable power supply, the dimensions being such and the speed of light being the centrifuge speed when divided by 2πr that the calculated speed of operation is on the order of 1.127×x10¹¹ RPM, recognizing that changes in the centrifuge diameter will influence the calculated operating speed, and said centrifuge being able to separate laser light particles from waves of the input laser light at this RPM.

2. The real physical solid state realization of a system which processes an external influence at a rate that enables the system to display two or more independent components of the external influence of the analyte and power source of the influence which are a wavicle.

3. The real physical structure and character of a model of an intrusive source and source of power and its effect upon a challenge, and previously stable and unremarkable, subsystem.
